(19) United States
(12) Patent Application Publication
(10) Pub. No.: US 2026/0258845 A1
(43) Pub. Date: Sep. 3, 2026

(54) POSITIVELY LOCKING CLUTCH WITH A LATCHING MECHANISM

(71) Applicant: Schaeffler Technologies AG & Co. KG, Herzogenaurach (DE)

(72) Inventors: Viktor Lichtenwald, Fürth (DE); Knut Erdmann, Nürnberg (DE)

(73) Assignee: Schaeffler Technologies AG & Co. KG, Herzogenaurach (DE)

(21) Appl. No.: 18/718,195

(22) PCT Filed: Dec. 7, 2022
(86) PCT No.: PCT/DE2022/100917

§ 371 Date: Jun. 10, 2024

(30) Foreign Application Priority Data
Dec. 16, 2021 (DE) 10 2021 133 448.9

(51) Int. Cl. F16D 11/10; F16D 11/00; F16D 23/12

(52) U.S. Cl. CPC F16D 11/10; F16D 23/12; F16D 2011/006

(57) ABSTRACT

A form-fit clutch includes a first rotary component with a first toothing, a second rotary component with a second toothing, an actuation element and a locking device. The actuation element is axially displaceable to adjust the form-fit clutch into a first clutch actuation state for torque transmission, or a second clutch actuation state in which the torque transmission is interrupted. The locking device is arranged to secure the form-fit clutch in the first clutch actuation state or in the second clutch actuation state. The locking device includes a locking element and a receiving element. The locking element is displaceable between a release position and a locking position, and coupled to the actuation element such that an actuation force from the actuation element may be transmitted to the first rotary component via the locking element. In the locking position, the locking element is form-fittingly connected to the receiving element.

### CROSS-REFERENCE TO RELATED APPLICATIONS

This application is the United States National Phase of PCT Appln. No. PCT/DE2022/100917 filed Dec. 7, 2022, which claims priority to German Application No. DE102021133448.9 filed Dec. 16, 2021, the entire disclosures of which are incorporated by reference herein.

### TECHNICAL FIELD

The present disclosure relates to a form-fit clutch.

### BACKGROUND

DE 10 2016 222 539 A1 describes a form-fit clutch with two spur-toothed, disc-shaped clutch bodies with a synchronizing device for adjusting the speed of the clutch bodies prior to engagement. The clutch bodies are axially spaced apart from one another and one clutch body is arranged such that it can move axially against the other clutch body in order to effect engagement of the spur toothing.

### SUMMARY

The present disclosure provides a form-fit clutch that can be designed more cost-effectively and a respective clutch actuation state that can be maintained more reliably and in a more energy-saving manner.

The form-fit clutch can be arranged in a vehicle. The form-fit clutch can be arranged in a drive train of the vehicle. The form-fit clutch can transmit a drive torque in order to propel the vehicle. The form-fit clutch can be arranged in an electric drive axle of the vehicle. The form-fit clutch can be designed to be bistable. The first and second clutch actuation states can each be secured.

The first rotary component can be a shaft or hub. The second rotary component can be a shaft or hub.

The form-fit clutch can be designed as a claw clutch. The toothing can be designed as a claw toothing.

The form-fit clutch can be engaged for torque transmission in the first clutch actuation state and disengaged for interruption of torque transmission in the second clutch actuation state.

The actuation element can be electromechanically displaceable. The actuation element can be connected in a form-fitting manner to a shift fork and/or shift rocker. The actuation element can be hydraulically displaceable. The actuation element can be displaceable by an actuating piston.

The actuation element is a separate component from the first and second rotary components. The actuation element can also be axially displaceable relative to the first and second rotary components in order to assume the second clutch actuation state. The actuation element can be displaceable in one axial direction in order to assume the first clutch actuation state and in the opposite axial direction in order to assume the second clutch actuation state.

The actuation element can transmit the actuation force at least partially to the first rotary component via the locking element in order to assume the first clutch actuation state. The locking element can at least partially be operatively arranged in a force-transmitting manner between the actuation element and the first rotary component.

The locking device can effect a transmission of the actuation force between the actuation element and the first rotary component. As a result, the actuation force to be applied via the actuation element can be adjusted in order to set a desired actuation force on the first rotary component. When the first clutch actuation state is assumed, the actuation force applied to the first rotary component can depend on the actuation force effecting it and applied to the actuation element. This dependency can be linear and/or non-linear. This dependency can be continuous and/or non-continuous.

In an example embodiment, the locking element may be radially displaceable depending on the displacement of the actuation element. The locking element can additionally or alternatively be axially displaceable depending on the displacement of the actuation element.

In an example embodiment, the locking element is radially further inward in the first clutch actuation state than in the second clutch actuation state. The actuation element can be arranged radially above the locking element, at least in the first clutch actuation state. The actuation element can radially secure the locking element at least in the first clutch actuation state. The receiving element can be arranged radially inside of the locking element.

In an example embodiment, the receiving element may have a recess, which is open in the radial direction and in which the locking element engages in a form-fitting manner in the locking position. The recess can be adapted to the shape of the ball. The recess can be designed to be cup-shaped.

In an example embodiment, the locking element may have at least one rotationally symmetrical locking component, which is connected in a form-fitting manner to the receiving element in the locking position. The locking component can be a ball or roller.

In an example embodiment, at least the first and/or second toothing may be axially displaceable depending on the clutch actuation state. The first toothing and/or second toothing can be a spur toothing or radial toothing. The first toothing can be an inner toothing or an outer toothing. The second toothing can be an inner toothing or an outer toothing. The first toothing can be formed directly or indirectly on the first rotary component. The second toothing can be formed directly or indirectly on the second rotary component.

The first toothing can be designed as a clutch body. The second toothing can be designed as a sliding sleeve. The second toothing can be axially displaceable on a sleeve carrier. The sleeve carrier can be connected to the second rotary component in a form-fitting manner. The sleeve carrier can be connected to the second toothing in a form-fitting manner. The sleeve carrier can be connected in a form-fitting manner to the second rotary component by means of an inner toothing. The sleeve carrier can be connected in a form-fitting manner to the second toothing by means of an outer toothing.

In an example embodiment, the second toothing may be axially displaceable and axially secured in the first and/or second clutch actuation state by the locking device. The locking device can be associated with the second toothing. The locking element can axially secure the second toothing in the locking position.

In an example embodiment, the actuation element may effect a radial movement of the locking element via a ramp region. The ramp region can be formed on the actuation element. The ramp region can effect a transmission of the actuation force. The actuation element and the locking element can be arranged in a radially overlapping manner in the release position. The actuation element and the locking element can be arranged radially above one another and in an axially overlapping manner in the locking position.

In an example embodiment, the actuation element may secure the locking element in the radial direction in the locking position. The actuation element can be arranged radially outside of the locking element. In the locking position, the locking element can be arranged radially between the receiving element and the actuation element.

In an example embodiment, the locking element may be acted upon via at least one spring element. The spring element can act on the locking element in an axial and/or radial direction. The spring element can act on the locking element directly or indirectly. The spring element can be acted upon by the locking element in the locking position. In the release position, the spring element may not be loaded by the locking element.

### BRIEF DESCRIPTION OF THE DRAWINGS

The present disclosure is described in detail below with reference to the drawings. In the figures:

FIG. 1 shows a cross-section of a form-fit clutch in a first clutch actuation state.

FIG. 2 shows the form-fit clutch of FIG. 1 in a second clutch actuation state.

### DETAILED DESCRIPTION

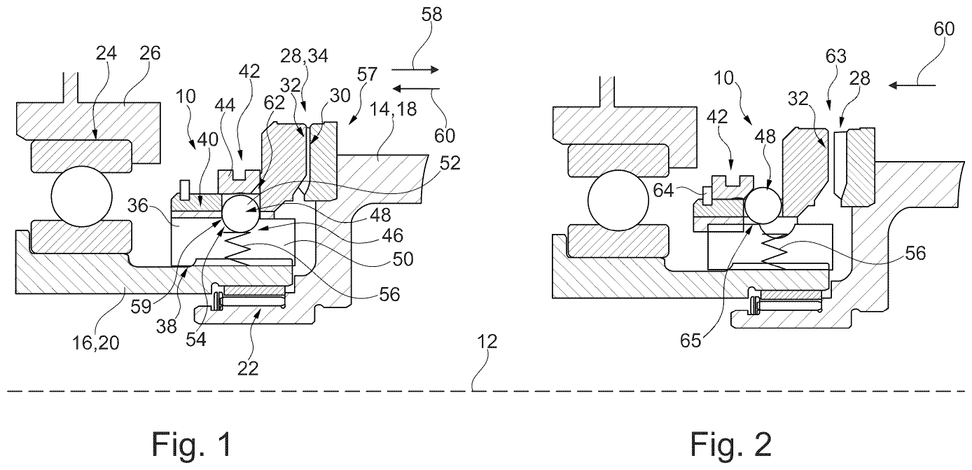

FIG. 1 shows a cross-section of a form-fit clutch in a first clutch actuation state. The form-fit clutch 10 is arranged in a vehicle for torque transmission. The form-fit clutch 10 comprises a first rotary component 14, which is rotatable about an axis of rotation 12 and is designed as a shaft, and furthermore a second rotary component 16, which is rotatable about the axis of rotation 12 and is designed as a shaft. The first rotary component 14 can be a drive shaft 18 and the second rotary component 16 can be an output shaft 20. The drive shaft 18 is mounted relative to the output shaft 20 via at least one bearing element 22. The bearing element 22 can be a radial needle bearing. The second rotary component 16 is mounted relative to a housing 26 via a further bearing element 24.

The form-fit clutch 10 has a toothing 28 which establishes the torque transmission when the form-fit clutch 10 is in a first clutch actuation state and interrupts the torque transmission when the form-fit clutch 10 is in a second clutch actuation state. The toothing 28 is formed from a first toothing 30 of the first rotary component 14 and a second toothing 32 of the second rotary component 16. The toothing 28 is designed as a claw toothing 34, with a spur toothing forming the first toothing 30 and a spur toothing forming the second toothing 32. In the first clutch actuation state shown here, the first and second toothing 30, 32 are connected to one another in a form-fitting manner for torque transmission.

The second toothing 32 is received in an axially displaceable manner on a sleeve carrier 36. The sleeve carrier 36 is arranged radially outside of the output shaft 20 and is connected in a form-fitting manner to the output shaft 20 by means of an inner toothing 38 and to the second toothing 32 by means of an outer toothing 40. The clutch actuation state can be switched by an actuation element 42 which is axially displaceable relative to the first and second rotary components 14, 15 and which introduces an actuation force in order to change the clutch actuation state. The actuation element 42 comprises a locking ring 44.

The form-fit clutch 10 comprises a locking device 46, which secures at least the first clutch actuation state, with a locking element 48, which is radially displaceable between a release position and a locking position securing the first clutch actuation state and is connected in a form-fitting manner to a receiving element 50 in the locking position. The receiving element 50 is integrally formed with the sleeve carrier 36.

The locking element 48 comprises at least one rotationally symmetrical locking component 52, preferably a ball, and the receiving element 50 comprises at least one recess 54, which is open in the radial direction and in which the locking element 48 engages in a form-fitting manner in the locking position. The recess 54 may be adapted to the shape of the ball 52. The recess 54 is designed to be cup-shaped, for example.

The locking element 48 is loaded in the locking position by a spring element 56 acting in the radial direction. If the actuation element 42 is displaced axially in order to assume the second clutch actuation state, with which the torque transmission via the toothing 28 is interrupted, then the spring element 56 presses the locking element 48 out of the recess 54 and the locking element 48 can be moved axially via the axial displacement of the second toothing 32. The locking element 48 is radially further inward in the first clutch actuation state than in the second clutch actuation state.

The actuation element 42 is displaced in a first direction 58 in order to assume the first clutch actuation state 57 shown here and is displaced in an opposite second direction 60 in order to assume the second clutch actuation state. If the actuation element 42 is moved in the first direction 58, then the axial displacement of the actuation element 42 is converted via a ramp region 62 on the actuation element 42 into a radial movement of the locking element 48 against the spring force of the spring element 56. As a result, the locking element 48 assumes the locking position 59, in which the actuation element 42 secures the locking element 48 in the radial direction and the locking element 48 axially secures the second toothing 32. The actuation element 42 is arranged radially outside of the locking element 48.

FIG. 2 shows the form-fit clutch of FIG. 1 in a second clutch actuation state. The form-fit clutch 10 is shown in the second clutch actuation state 63, in which the torque transmission via the toothing 28 is interrupted. The second toothing 32 is displaced in the second direction 60 compared to the first clutch actuation state.

If the actuation element 42 is moved in the second direction 60 starting from the first clutch actuation state in order to assume the second clutch actuation state 63, the locking element 48 is moved radially outwards by the spring element 56. The actuation element 42 displaces the second toothing 32 in the second direction 60 via a locking ring 64 on the second toothing 32. The locking element 48 can move radially outwards as the actuation element 42 is displaced in the second direction 60 and is thus in a release position 65.

When the first clutch actuation state is assumed, the actuation element 42 is coupled in a force-transmitting manner to the locking element 48 for transmitting the actuation force to the first rotary component 14. In this regard, the axial movement of the actuation element 42 causes the locking element 48 to be displaced axially and radially against the spring force of the spring element 56. The locking element 48 transmits the actuation force originating from the actuation element 42 to the second toothing 32.

### REFERENCE NUMERALS

10 Form-fit clutch
12 Axis of rotation
14 First rotary component
16 Second rotary component
18 Drive shaft
20 Output shaft
22 Bearing element
24 Bearing element
26 Housing
28 Toothing
30 First toothing
32 Second toothing
34 Claw toothing
36 Sleeve carrier
38 Inner toothing
40 Outer toothing
42 Actuation element
44 Locking ring
46 Locking device
48 Locking element
50 Receiving element
52 Locking component
54 Recess
56 Spring element
57 First clutch actuation state
58 First direction
59 Locking position
60 Second direction
62 Ramp region
63 Second clutch actuation state
64 Locking ring
65 Release position

1. A form-fit clutch for influencing a torque transmission between a first rotary component, which is rotatable about an axis of rotation and a second rotary component, and having
a toothing, which comprises a first toothing on the first rotary component and a second toothing on the second rotary component, which can be connected thereto in a form-fitting manner for torque transmission and which establishes the torque transmission in a first clutch actuation state and interrupts the torque transmission in a second clutch actuation state,
a displaceable actuation element for changing the clutch actuation state by means of an actuation force,
wherein:
a locking device securing the first or the second clutch actuation state is arranged, comprising at least one locking element, which is displaceable between a release position and a locking position securing the respective clutch actuation state and which is connected in a form-fitting manner to a receiving element in the locking position, wherein
the actuation element is axially displaceable relative to the first and second rotary components in order to assume the first clutch actuation state and is coupled in a force-transmitting manner to the locking element for transmitting the actuation force via the locking element to the first rotary component.

2. The form-fit clutch according to claim 1, wherein the locking element is radially displaceable depending on displacement of the actuation element.

3. The form-fit clutch according to claim 1, wherein the locking element is radially further inward in the first clutch actuation state than in the second clutch actuation state.

4. The form-fit clutch according to claim 1, wherein the receiving element has a recess, which is open in a radial direction and in which the locking element engages in a form-fitting manner in the locking position.

5. The form-fit clutch according to claim 1, wherein the locking element comprises at least one rotationally symmetrical locking component, which is connected in a form-fitting manner to the receiving element in the locking position.

6. The form-fit clutch according to claim 1, wherein the first toothing or the second toothing is axially displaceable depending on the clutch actuation state.

7. The form-fit clutch according to claim 6, wherein the second toothing is axially displaceable and is axially secured in the first or the second clutch actuation state by the locking device.

8. The form-fit clutch according to claim 1, wherein the actuation element effects a radial movement of the locking element via a ramp region.

9. The form-fit clutch according to claim 1, wherein the actuation element secures the locking element in a radial direction in the locking position.

10. The form-fit clutch according to claim 1, wherein the locking element is acted upon via at least one spring element.

11. A form-fit clutch comprising:
a first rotary component comprising a first toothing;
a second rotary component comprising a second toothing, connectable to the first toothing in a form-fitting manner for torque transmission between the first rotary component and the second rotary component in a first clutch actuation state;
an actuation element, axially displaceable relative to the first rotary component and the second rotary component to adjust the form-fit clutch into the first clutch actuation state or a second clutch actuation state in which the torque transmission is interrupted;
a locking device arranged to secure the form-fit clutch in the first clutch actuation state or in the second clutch actuation state, the locking device comprising:
a locking element:
displaceable between a release position and a locking position; and
coupled to the actuation element such that an actuation force from the actuation element may be transmitted to the first rotary component via the locking element; and
a receiving element, the locking element being form-fittingly connected to the receiving element when the locking element is in the locking position.

12. The form-fit clutch of claim 11, wherein displacement of the actuation element affects radial displacement of the locking element.

13. The form-fit clutch of claim 12, wherein the locking element is arranged further radially inward when the form-fit clutch is in the first clutch actuation state than when the form-fit clutch is in the second clutch actuation state.

14. The form-fit clutch of claim 11 wherein:
the receiving element comprises a recess open in a radial direction; and
the locking element is arranged to engage the recess in a form-fitting manner when the locking element is in the locking position.

15. The form-fit clutch of claim 11, wherein the locking element comprises a rotationally symmetrical locking component.

16. The form-fit clutch of claim 11 wherein the first toothing is axially displaced relative to the second toothing when the form-fit clutch is adjusted between the first clutch actuation state and the second clutch actuation state.

17. The form-fit clutch of claim 16, wherein the second toothing is axially secured relative to the first toothing in the first clutch actuation state.

18. The form-fit clutch of claim 11, wherein the actuation element comprises a ramp region for radially displacing the locking element.

19. The form-fit clutch of claim 11 wherein the locking element is radially secured by the actuation element when the locking element is in the locking position.

20. The form-fit clutch of claim 11 further comprising a spring element arranged to apply a radial force to the locking element.
